(19) United States
(12) Patent Application Publication
(10) Pub. No.: US 2009/0147269 A1
(43) Pub. Date: Jun. 11, 2009

(54) Interferometric nanoimaging system

(76) Inventor: Wayne E. Moore, Columbia, MD (US)

Correspondence Address: WILLIAM S RAMSEY, ESQ, 5253 EVEN STAR PLACE, COLUMBIA, MD, 21044, US

(21) Appl. No.: 12/290,592

(22) Filed: Oct. 31, 2008

Related U.S. Application Data
(60) Provisional application No. 61/001,917, filed on Nov. 5, 2007.

(51) Int. Cl. G01B 9/02

(52) U.S. Cl. 356/512

(57) ABSTRACT

The invention is a means of providing focusing and the use of focal methods to improve the imaging and meteorological performance of an interferometric, non-image forming system for use in metrology and nanoscale imaging.

### BACKGROUND

The invention is an improvement to an interferometric metrology and imaging tool patented as U.S. Pat. No. 7,136,168 B2, “Interferometric Topological Metrology with Pre-Established Reference Scale” by Lev Dulman, hereinafter referred to as U.S. Pat. No. 168. The invention describes a means of creating interferometric fringes that contain three-dimensional information about a specimen, a practical means of recovering that information in a compact form, and a means of creating 3-dimensional meteorological analyses and/or images of the specimen from the recovered information. Of particular value of 168 is that the instrument can be implemented as a optical microscope with resolution in the range of a few nanometers or less. Of further interest and of importance to the improvement(s) claimed herein, the methods of 168 depend on the use of optical plane wave illumination of the specimen and the subsequent interference of plane waves. The invention thus described in 168 has no focal plane, the working distance is substantially not limited, and the potential for multipath optical interference to confuse the data is a present challenge to the realization of a commercially viable tool. The improvement recognizes additional capability though the use of focused illumination and spatial filtering wherein the improvement relies heavily on the invention of 168 but extends and improves the optical implementation making use of focusing methods and signal improvement methods that were not obvious at the time of the invention.

### DETAILED DESCRIPTION

The improvement is a means of providing focusing and the use of focal methods to improve the imaging performance of the non-image forming system described in the basic U.S. Pat. No. 168. To best explain the improvement it is necessary to clarify the invention specifically disclosed as 168. In the basic patent we note that Column 13 discusses a plane wave system in which a planar reference mirror is used. Moreover, while it is not necessary to use plane wave light, it is more convenient to do so. Doing so provides straight line fringes. Similarly, if the object and reference beams had exactly the same radius of curvature at the plane of interference, straight line fringes would result, however, this condition could only be met for one plane in object space. So, if the sample stage were perfectly flat, undistorted straight line fringes would result. If however the sample were not perfectly flat the diverging object wave reflecting from surfaces at a distance other than that required to produce straight fringes, would contain a component of curvature that is feature height dependent, and would make the actual feature height more difficult to accurately compute. So, while other than plane wave implementations are implied within the scope of the patent, it is clear that the intended embodiment makes use of plane waves for both the reference and the object waves. As such, no image is formed at any plane within the invention, and if an image were formed by embodying additional lenses into the system, the formation of that image would be outside the description provided by 168 and no use could be made of that image within the scope of 168. Similarly, focusing of the optical system is not described in 168, and unlike many systems involving the collection of high resolution specimen information using optical means, discussion of focal planes and the use of focused optics is avoided in 168. Accordingly, of importance to the improvement to be described herein, it is necessary to provide a clarification regarding the focusing, and magnification as described according to 168. Here is quoted Section 5.0 “High Resolution Topographical Description through Interleaving of Multiple Topographical Measurements”, Column 20 Lines 9 through 26:
“Regardless as to whether or not or which technique (or combination of techniques) is used to create different sets of interleavable tracings, a word about magnification and the fringe lines is also in order. With respect to magnification, referring back to FIG. 10A, note that a magnifying lens 1010 is included. The “per pixel unit of sample height measurement” parameter and the “per pixel unit of distance along the x and y directions of the sample stage” parameter can be enhanced by incorporating magnification into the interferometer. For example, if without magnification there exist 10 pixels between neighboring fringe lines (e.g., as observed in FIG. 9a), providing 10 times magnification will effectively move neighboring fringe lines to be 100 pixels apart rather than 10 pixels apart. Because the fringe lines are still to be regarded as being separated by a distance of .lamda./2, the per pixel unit of sample height measurement may still be determined from .lamda./(2N). As such, a tenfold increase in N corresponds to a tenfold increase in per change in sample height.

The concept of magnification as discussed in the quoted paragraph above from the basic U.S. Pat. No. (168) is correct but incomplete. Magnification is known to those in the art to described a scale change between two focal planes in an imaging system. Since the invention is described as using plane waves, and since by definition, images are formed from converging rays of light and cannot be formed by the interference of two plane waves, the term magnification has no meaning. Accordingly, 168 has inadvertently left a critical parameter without explanation. Nor, in fact, is the correct explanation immediately obvious to one skilled in the art. However, in the context of the improvement, the meaning and means of clearly controlling magnification and focus are described so that embodiments of 168 can be designed with capabilities exceeding those initially described and taught in 168.

### Magnification in an Imaging Interferometer System

Keeping in mind that plane waves ultimately impinge and interfere upon the detector plane, and only interference fringes are formed on the detector plane. In order for magnification to have meaning in the conventional sense, an image must be formed that maps points from the specimen plane to points in the image plane with a linear scale factor between the values of point coordinates in the object and those replicated in the image planes. If, for a simple example, a point in and orthogonal coordinate system located in the object plane has the X, Y position of 2, 2, then with a magnification of 10-fold, those points would be linearly mapped to coordinates 20,20 in an identically scaled coordinate system in the image plane. Ignoring the effects of aberrations, in conventional optical terminology, a completely deterministic linear relationship, known as the Lens Maker's Equation, exists between the location of the object plane relative to the focal length on the “input side” of a magnifying lens, and the location of the image plane relative to the focal length on the “output-side” of the lens. This relationship requires that an image be formed, yet, with only a collimated beam of plane waves incident upon the detector plane, according to the system described at length in 168, no image can be formed. Accordingly, magnification in the conventional sense, is not defined.

Nevertheless there exists more than one means of describing a linear mapping between a specific point in the specimen plane and a complementary point in the detector plane that accounts for real optical magnification without the formation of an image. 168 describes a lenseless system in which the collimated plane wave beam incident upon the specimen is reflected directly to the detector plane with no change of beam lateral dimensions. In this most simple case, assuming a perfect optical system that creates no distortion to the plane waves as they move from the specimen to the detector, each point in the plane wave front reflected from the specimen is exactly the same at the detector plane. In this case there is a one-to-one mapping of the reflected beam at the surface of the specimen and the reflected beam as it impinges upon the detector.

However, if a lens is placed in the object beam path there are two possible cases that can in fact comprise magnification and be consistent with the use of plane wave interference:

1. A lens is used to alter the diameter of the collimated beam of plane waves incident upon the specimen plane.

2. A lens is focused upon the specimen plane in such a manner that the beam waist of the quasi-Gaussian laser beam employed falls upon the specimen plane.

These are two completely different cases of plane wave illumination that are not distinguished in the basic patent, however, they have dramatically different implications on the actual embodiments of the invention and further improvements revealed herein.

In the first case the Field of View (FOV) on the specimen plane is the diameter (or the illuminated spatial extent) of the collimated beam incident on the specimen plane. Since laser beams and circular optics are often used, the term “diameter” is used to describe a consistent measure of related beam sizes. Of course, with a CCD detector array, or similar device, the active detecting area is a rectangular array of pixels, and the actual field of view is rectangular. In that case one might visualize the term “diameter” to equate to the “diagonal distance” across a the rectangular detector inscribed within the illuminating circle.

In the second case, the FOV is the diameter of the Gaussian beam waist of the converging, non-collimated, object beam as “focused” upon the specimen plane by a lens. The beam waist of a focused Gaussian beam is comprised of plane waves. The diameter of the waist, and hence the FOV, can be adjusted by adjusting the optical design.

In both cases the “magnification” is given by the diameter of the beam incident upon the detector plane divided by the diameter on the beam incident on the specimen. In a properly designed optical system, this number can be many thousand fold without encountering aberration because, in each case, the illuminated areas are comprised of monochromatic plane wave illumination. In this case, of course, there is no diffraction limitation and spherical aberrations can be corrected in the usual manners as known to those in the art of lens system design.

In the detector plane, the displacement between fringes is in no way related to the “magnification” of the specimen plane. The fringe displacement is purely a function of the operating optical wavelength and the angle between the object and reference plane wave beams at the detector plane.

The scale distance relative to the specimen between fringes as related to the field of view is, however, proportional to the magnification. So that if a 10 micron specimen FOV is mapped to just fill a 1 cm detector, the magnification is 1,000. Thus with magnification defined as 1,000, a 10 nanometer square feature on the specimen maps to cover a 10 micron square on the detector.

The detector is made of an array of photoreceptors called pixels. For an example case, the instrument might be made using a detector having square pixels that are 2×2 microns square. The 10 micron square feature as mapped to the detector thus covers an area that is 5 pixels by 5 pixels.

The fringes that appear on the detector surface are spaced apart by the distance S given by

$$S = \frac{λ}{sin α}$$

where λ is the operating wavelength of the system and α is the angle between the interfering plane waves. This is in no way related to the magnification. For a proper choice of wavelength and angle, the peak-to-peak distance on the surface of the detector between bright fringes could be, e.g., 100 microns. If that were the case, there would fifty 2-micron pixels from the peak of one fringe to the peak of the next.

Considering that the ratio of fields of view between the detector and the sample is 1,000, the factor we have defined as the magnification, the distance of 100 microns on the detector represents a distance of 100 nanometers on the specimen. Then by the same mapping rule, the 50 pixels (2×2 microns) in the detector plane can be thought of as 50 pixels, or sampling areas, of 2×2 nanometers in the specimen plane. Each pixel therefore represents a specimen distance of 2 nm in each lateral direction for this case with magnification of 1000.

If the magnification were changed to 2000, there would be no change in the distance between fringes. The apparent pixel size on the specimen would however become 1 nanometer instead of 2 nanometers. Thus the 50 pixels that measure the 100 microns between fringes on the detector, now measure 50 nm on the specimen. So magnification accomplishes a linear reduction of the effective pixel size on the specimen.

To relate this mathematically we rename the effective pixel dimension on the specimen as “resolution”, R, and define that as the smallest distance that can be measured on a specimen for a given set of conditions. Then:

R=λ/Nm sin α

Where λ is the operating optical wavelength, N is the number of pixels between fringes, m is the magnification given as the ratio of Detector FOV to Sample FOV, and α is the angle between the interfering plane waves.

### The Focused Gaussian Beam Case

The first case above describes a configuration using collimated, unfocused, beams of plane waves according to 168. The second case however, that of using the plane wave present at the waist of a focused Gaussian beam as the plane wave incident on the specimen, presents a situation that paradoxically implies that plane wave interference can be accomplished while operating with a focused beam of illumination. This mode of operation is not described in 168.

The operation of some indirect imaging systems called confocal laser scanning microscopes, deliberately focus laser light to a small spot and collect light reflected from that spot to create one pixel of image information. The point of light is scanned, raster style, across the specimen. Using electronic means known to many in the field, light from many consecutive points on the specimen is collected and used with computational electronics to construct an electronic or digital image. In such systems using lasers the “spot” of light that is scanned is in fact a focused Gaussian beam arranged so that the smallest diameter of the beam waist is the diameter of the scanned spot. Doing this permits further imaging optics in the system to filter out light that could occur from regions other than the focal plane of the Gaussian spot, i.e., that plane in which the focused beam is a plane wave.

When light is reflected by a specimen from a focused spot back into the lens that formed the spot, the diameter of the collimated beam leaving that lens can be made to be equal to the diameter of the collimated beam that was incident upon the lens. This is accomplished by simply limiting the size of the output aperture of the focusing lens.

Thus, a collimated Gaussian beam, or a real laser beam that is realistically described as approximately Gaussian, can be expanded and collimated by well known means. That collimated input beam of radius wₒ can then be made to pass into a focusing element that will create a spot with minimum radius w_{f} at the focal length of the lens. That spot can have radius w_{f} of almost any desired dimension and can specifically be made to have dimension in the range of 1 to 20 microns. That radius is the radius of the FOV on the specimen. It is comprised of a pure plane wave. The radius of the focal spot is given by

$${w}_{f} = \frac{λ {fM}^{2}}{π {w}_{0}}$$

where w_{f} is the focal spot diameter, f is the focal length of the lens, M is a beam quality factor used in the art to describe the degree to which a beam is truly Gaussian (M=1 is ideal), and wₒ is the radius of the collimated input beam.

Of particular importance, and unique to this improved operating mode of the invention of 168, the light reflecting from the focal spot contains all of the phase information required to construct the 3-dimensional image by the interferometric means of 168. Earlier it was said that the light reflected from the focal plane back through the focusing lens will emerge as a collimated plane wave object beam that can be directed to the detector and interfered with a reference beam in the manner of 168. In this case, therefore, the magnification is given as the ratio of the radius of the collimated beam exiting the focusing lens, which we assume here is made to be the same as wₒ, to the focused beam waist radius w_{f}.

$$m = \frac{{w}_{0}}{{w}_{f}}$$

Depending on the nature of the specimen, light focused to the radius w_{f} at a specific focal plane in or upon the specimen, can travel beyond that specific focal plane and reflect from surfaces within the FOV that lie in different planes. Such light has different properties from light reflected from the focal plane: it is not planar but is rather spherically divergent; it is reflected with a different phase relationship to light in the focal plane; and it represents an object source beyond the focal plane of the lens, hence it would be imaged in a different plane. Therefore, if a second lens were placed in this collimated object beam leaving the first focusing lens, the beam will become focused to a second focal spot in the particular focal plane of the second lens. At all locations the object beam contains all of the phase information required to depict the sample according to the interferometric means of 168. Since that information originates from the plane wave region of the focal spot on the specimen, any incident light that reflects from surfaces that are not located in the focal plane, will not be focused to the same plane as light from the focal plane. Therefore, if a pinhole of proper size is placed at the focal plane of the second lens, only light originating from the focal plane of the first lens on the specimen will pass unattenuated through the pin hole. Light reflecting from surfaces nearer or farther from the focal plane of the objective lens will be attenuated by the pinhole or will miss the pinhole completely.

In the case of imaging through media that can have multiple reflecting layers, or media having multiple reflecting objects, or multiple objects that can modulate the phase of the object beam, according the concepts of 168, located in planes nearer or farther from the objective focal plane and in the field of view of the system, multiple fringe patterns can be generated by the Case 1 design envisioned and described in 168. Since all of the light is coherent and monochromatic, all fringes will have the same period regardless of the plane from which they originate. Accordingly, by 168 fringes can arrive from many different planes in multilayer structures and can harmonically add or subtract with the fringes from the desired plane. Depending on the nature of the layers that generate fringes from unwanted planes, this can make the task of determining the desired fringe using the methods of 168 difficult or impossible.

By the improved design, many or all of the unwanted interfering fringes can be eliminated by optical spatial filtering using a pinhole described above.

Cases of importance in which the improved design can benefit the performance of the 168 invention include, but are not necessarily limited to:

a. Imaging through multiple reflective layers of more or less transparent material such as semiconductors where in relatively thick layers of transparent passivating oxides can contribute a strong reflection that can interfere with embedded semiconductor features several hundreds of nanometers or microns beneath the upper surface of the passivating layer.

b. Imaging through silicon itself where a laser of appropriate wavelength to pass through silicon is used. Reflections from the first surface of the silicon can produce fringes having very irregular phase shape because the silicon may not be highly polished. Such reflections can produce interference patterns that mask the information from within the silicon.

c. Imaging through transparent media, such as liquids or biological materials, where light is focused to a given plane within the media and allowed to transmit through the material before entering a re-collimating lens.

Each of these cases will be described in terms of the beneficial affects of the improvement.

### BRIEF DESCRIPTION OF THE DRAWINGS

FIG. 1 illustrates a collimated plane wave beam incident upon a specimen that creates reflections from more than one plane and the resulting phase displacements of the wave front.

FIG. 2 illustrates a focused laser beam incident upon a specimen that creates reflections from more than one plane wherein the Gaussian beam waist is defined as the focal plane.

FIG. 3 illustrates the use of a spatial filter to block light reflected from planes removed from the focal plane.

FIG. 4 illustrates the use of a spatial filter to block light reflected from planes removed from the focal plane arranged in a manner to also spatially filter the reference beam

FIG. 5 illustrates the use of a spatial filter to block light reflected from planes removed from the focal plane arranged in a manner that permits the reference beam to bypass the spatial filter

FIG. 6 illustrates the use of the in the invention as it might be configured for transmitted light imaging.

FIG. 7 illustrates transparent media containing objects that might be reflective or transmissive of incident light.

### IMAGING MULTILAYER MATERIALS

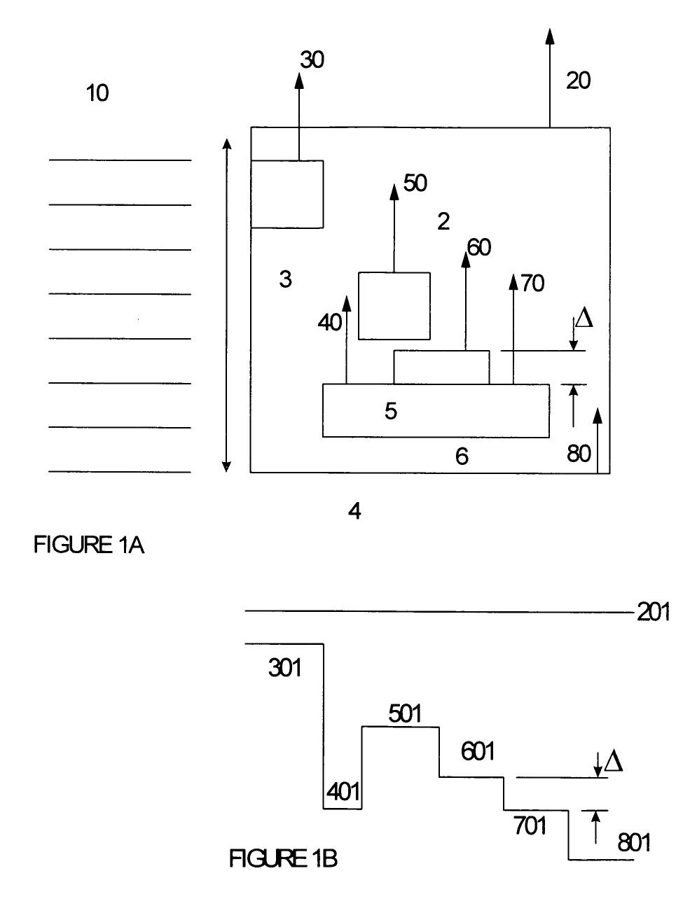

FIG. 1 illustrates a simplified multilayer imaging situation illuminated with a plane wave column 10 according to 168. In this case there is no focal plane and the working distance can be considered infinite. This figure depicts a sectional view of multiple reflective structures 3, 4, 5, 6 embedded within a transparent material 2 with reflections 20, 30, 40, 50, 60, 70, 80 returning toward the detector which is not shown. The plane waves 10 represent the collimated beam of periodic plane waves incident upon all surfaces in the structure.

Surface 2 is a 2-dimensional flat surface extending into the page. A reflection from that surface 20 is a plane wave of wavelength λ identical to the source wavelength depicted by 201. The wavefront reflected from the embedded structures is comprised of different phase regions 301, 401, 501, 601, 701, 801. shown in FIG. 1b. Both reflected plane waves have the same period and travel toward the detector where an undistorted reference plane wave will interfere with the superposition of the periodic reflections, 201 and 301-801. Upon interference fringes will be formed on the detector face which comprise the superposition of 201 and 301-801 as shown in FIG. 1c. As may be apparent from the drawing, determining which fringe relates to which feature is challenging and perhaps impossible.

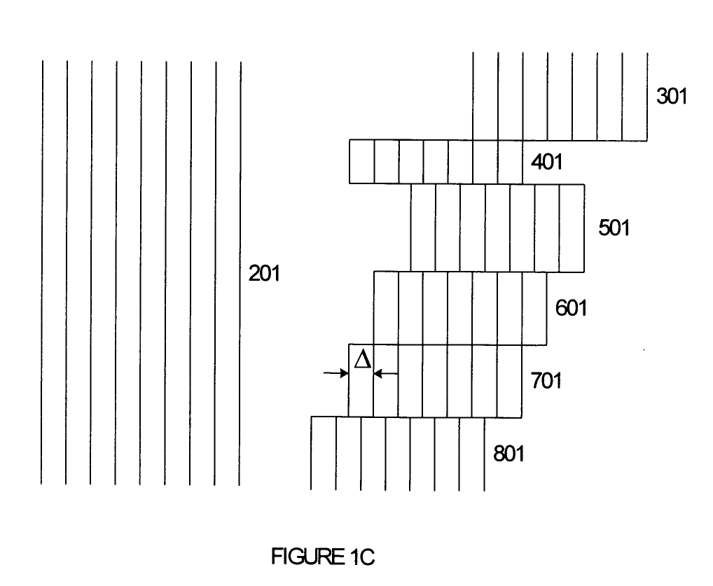

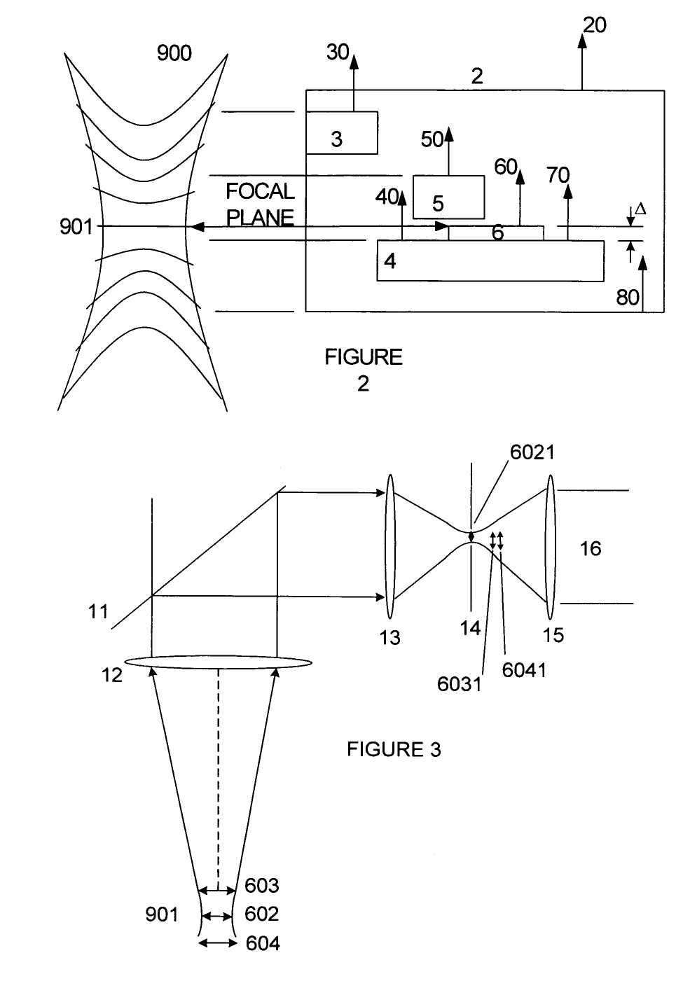

FIG. 2 illustrates the same structure illuminated by a focused Gaussian beam 900 adjusted so that the focal plane 901, also known as the beam waist, corresponds with one particular surface 6 of height A relative to surface 7 buried within the structure 2. Reflections 20, 30, 40, 50, 60, 70, 80 will all occur much as in FIG. 1. FIG. 3 then shows the result of when the reflected beam is re-collimated by the focusing lens 12 and then focused through a spatial filter 13,14,15. Each reflection from a different plane will focus at a different location. Specifically the actual focal plane can be made to focus by a lens 13 to a very small spot 6021, much smaller that the Gaussian spot 602 illuminating the specimen plane. Reflections from other planes 603 and 604, nearer or farther from the focal plane 602, will focus nearer or farther from the pinhole in locations schematically represented as 6031 and 6041 respectively, depending on conventional image-forming optical calculations. All or most of the light from the focal spot 602 will pass through the pinhole 14, while a smaller fraction of light from other planes will pass. This substantially reduces light from out-of-focus planes and simplifies the fringe identification and tracking. The diameter of the focal spot can be made large enough to illuminate the entire structure 2, but only plane 602 is in focus.

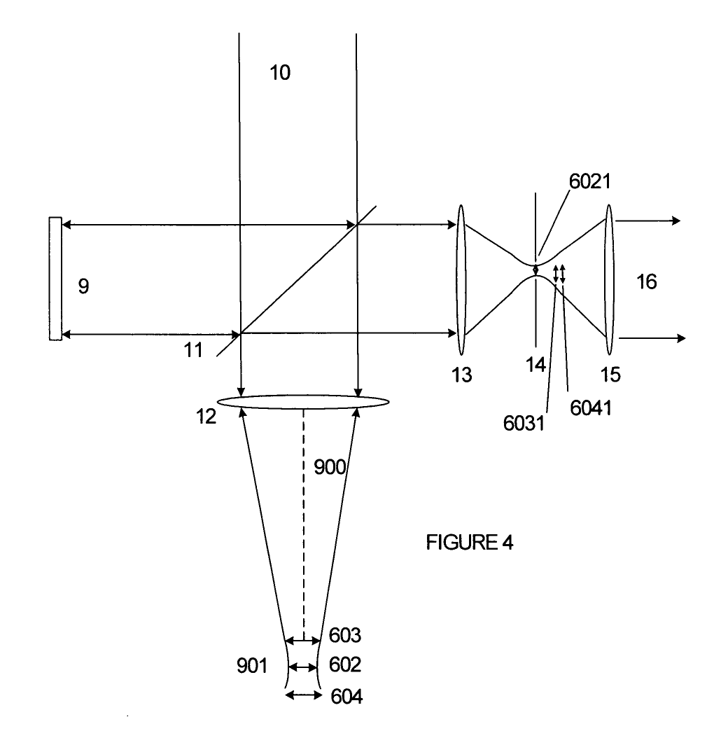

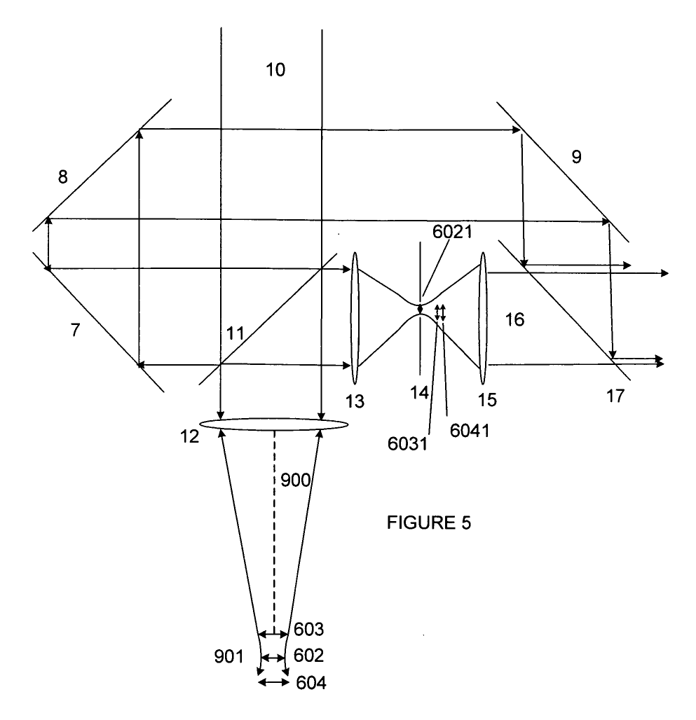

Light passing though the pinhole can be re-collimated by another lens 15 to form a collimated beam of plane waves 16 containing all of the phase information resident in the reflected beam from plane 602. With judicious choices of spatial filter design it may be possible to pass the reference beam collinearly through the same pinhole as depicted in FIG. 4. Alternatively, the reference beam can be made to bypass the object beam spatial filter by means readily apparent to those familiar with optical design indicated in FIG. 5.

In the case of FIG. 4 the collimated input laser beam 10 encounters a beam splitter 11 and reflects to a reference mirror 9. The beam reflected from the reference mirror passes back through the beam splitter ii and combines with the beam reflected from the specimen in plane 901. The combined beams pass through lens 13, pinhole 14 and lens 16 and travel onward to the detector which is not shown.

In the case of FIG. 5 the collimated laser input beam 10 encounters the beam splitter 11, is partially directed to mirror 7 where it is reflected again to mirror 8 and subsequently to mirror 9. Mirror 9 can be identified as the reference mirror, but any of the reflectors, 7, 8 or 9 could also serve as the reference mirror by having adjustable mounting as required for that mirror. The reference beam, being the beam reflected by the reference mirror recombines with the object beam 900 at a second beam splitter 17 and the combined beams then travel onward to the detector which is not shown. FIG. 5 depicts one of many possible arrangements that permit the reference beam to reach the detector without passing through the pinhole 14 that is used to filter the object beam. This has the potential advantage that light from the object beam could have special filtering needs that are not compatible with the requirements of the reference beam. One example is the case that in order to accomplish the desired control of the interference fringe spacing, the reference beam must travel at a small adjustable angle relative to the optical axis of the object beam and it may not pass through a pinhole optimized for the object beam. These and many other designs can accomplish the intent of the improvement.

### Imaging Through Silicon

It is well known that semiconductor inspection systems often seek to image structures that are within the structure of the semiconductor. The semiconductor substrate may be silicon, in which case it is possible to use light of a wavelength at which silicon is substantially transparent to illuminate structures made of a different material that can reflect the light. For example laser light at the wavelength of 1.2 to 1.3 microns is often used for this purpose. In practice the semiconductor is unpackaged. The circuitry of the semiconductor can be found within the first 20 microns of the top surface of the device, but features of interest are often obscured by the metallic conductor paths that interconnect the embedded elements of the device. Common practice is to thin the reverse side of the device. Using various means many microns of silicon are removed so that that the laser light can access the desired components with minimal distortion and attenuation. Using a conventional optical system, light of this relative long wavelength suffers from the so-called “diffraction limit” and thereby can produce images of resolution limited to about one-half the wavelength of the light used. The need is to resolve semiconductor features with size in the range of 10 nanometers or less, but even the most sophisticated imaging systems are only capable of about 200 nm resolution. These means, which include, for example, silicon immersion lens methods, are completely destructive to the semiconductor and suffer many difficulties in practice. Alternatively, x-ray systems can reach 50 nm resolution or better but are very costly and difficult to use. Therefore, a means to see through the semiconductor is sought.

The invention of 168 provides a solution to this need. The improvement describe above for layered media improves the ability to accomplish imaging through the backside of a semiconductor. The generalized case depicted in FIGS. 1 and 2 apply to this discussion. The material comprising body 2 can be any material that is effectively transparent at the wavelength used.

### Imaging Through Fluids or Biological Media

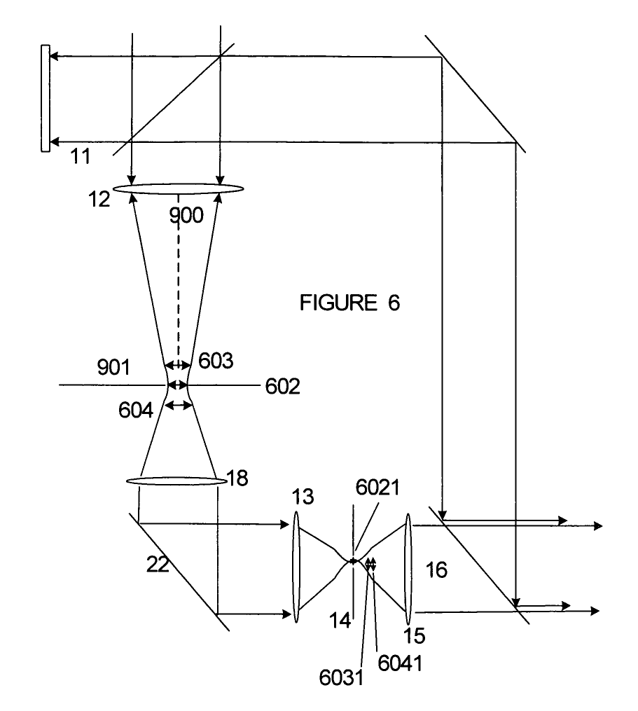

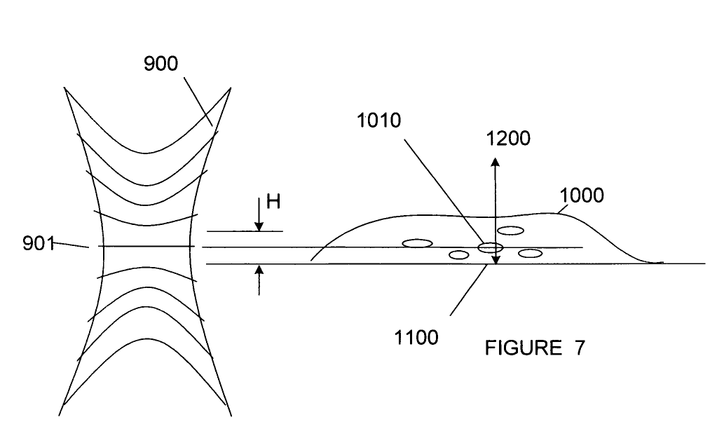

Again the generalized concept depicted in FIGS. 1 and 2 can be thought of in terms of material 2 being a fluid and the various reflecting objects within that fluid 3, 4, 5, 6 could be biomolecules, DNA strands, or other materials commonly found in living cells and tissue. Such materials are often considered to be transparent meaning that they neither absorb nor reflect substantial amounts of light but rather permit light to pass through. Nevertheless, it is well known that biomaterials can be imaged using interferometric means and in fact, prior to the invention of 168, the term “interference microscope” implied the use of interferometric means to image biological “phase” objects, or other more or less transparent materials, that can change the phase of light passing through them. There are at least two preferred means to accomplish imaging of biological objects depicted schematically in FIGS. 6 and 7.

Collimated or focused Gaussian beams according to FIGS. 1 and 2 can be employed in either: a reflected mode system as described for FIG. 1, or 2; a transmission mode system FIG. 6, wherein light is not reflected back to beamsplitter 11; or a reflected light system as depicted in FIG. 7 wherein a reflective surface is placed beneath the transparent media causing light to pass through the media and bodies within it twice.

In the case of FIG. 6 the light passes through the specimen located in plane 901 and travels onward to subsequent elements that could comprise a collimating lens 18, in the case that a focused beam is used as depicted in the FIG. 6, although if a collimated beam is used, lens 18 is not needed; mirror 22, and then, as the design may require, into a spatial filter assembly comprising elements 13,14,15 as previously described.

A design of the type shown in FIG. 7 employs a reflective surface 1100 placed beneath a transparent material 1000. The transparent material can contain other more or less transparent bodies 1010. Again the specimen comprising 1000 and 1010 can be illuminated with either a collimated or focused beam. The case shown illustrates a focused beam 900 drawn to the side of the specimen for clarity. In practice the beam 900 might impinge on the specimen at location 1200. The focal waist of the beam is made to coincide more or less with a body 1010 within the material 1000. Light 1200 passes through the body 1010 to the reflective surface 1100 and reflects back through the body 1010 thereby doubling the phase delay introduced by the body 1010 and the material 1000. This configuration permits the use of the same reflected light optical design for both types of samples.

### Computational Imaging

The use of the meteorologically accurate three-dimensional measurements obtained by any of the embodiments described herein can be transformed computationally through a process often called rendering to form a three dimensional image. In image formation of this type there is no requirement to form an optical image at any place in the entire process of managing the light path or collecting information from the optical signals. It is understood, base on 168, that an electronic detector array like a CCD or CMOS detector can be employed to produced 2-dimensional spatial sampling of the plane of interference. In this discussion we have assumed that the interference pattern is always formed substantially in the plane of the active electronic elements that convert photon energy to electrical energy. The use of such a detector inherently results in a stream of electrical signals that contain information from each discrete sensing element, or pixel, location. That information can then be processed to create an image. In the application described here and elsewhere in U.S. Pat. No. 6,999,181 B2 the intensity information contained in the electrical signal is not necessarily used, but the two-dimensional location of the pixel, or pixel X, Y coordinated location is used. The co-ordinate information can be mathematically used to computationally describe all three dimension of the specimen, thus creating a file of three dimensional point data. When properly processed using computation rendering means, this geometrical information can be used to map a three dimensional surface, and that surface can subsequently be provided with textures, shadows, colors, and lighting effects to produce a substantially photo-realistic image of the specimen surface.

1. An improvement to the optical interferometric system of U.S. Pat. No. 7,136,168 B2, “Interferometric Topological Metrology with Pre-Established Reference Scale” comprising the use of focusing optics to create a small field of view illuminated by plane waves comprising:
a. A focusing lens to focus a collimated beam of plane wave light from a laser to form a spot of predetermined diameter in the plane of the specimen
b. The use of the same focusing lens to re-collimate the light reflected from the illuminated spot in the specimen plane
c. The interference of the reflected collimated plane waves collected from the specimen surface with a reference plane wave with interference occurring in the plane of a detector
d. The subsequent extraction of the phase information within the reflected collimated plane waves collected from the specimen surface to obtain meteorologically accurate three-dimensional measurements of features in the specimen plane.
e. The use of the meteorologically accurate three-dimensional measurements to computationally form a three dimensional image of specimen features.

2. The improvement of claim 1 wherein the focusing lens is a microscope objective

3. The improvement of claim 1 wherein the predetermined spot diameter is define as the Gaussian beam waist of the focused collimated beam of laser light

4. The improvement of claim 1 wherein the predetermined spot diameter in the specimen plane comprises the field of view of the system.

5. The improvement of claim 1 wherein the waist of the focused spot is occupied by optical plane waves

6. An improvement to the optical interferometric system of U.S. Pat. No. 7,136,168 B2, “Interferometric Topological Metrology with Pre-Established Reference Scale” comprising the use of focusing optics to create a small field of view illuminated by plane waves comprising:
a. A focusing lens to focus a collimated beam of plane wave light from a laser to form a spot of predetermined diameter in the plane of the specimen
b. The use of the same focusing lens to re-collimate light reflected from the illuminated spot in the specimen plane
c. The use of a spatial filter in the optical path after the re-collimating lens to remove or minimize optical information from surfaces other than those located in the immediate vicinity of the focal plane, aka the beam waist, of the focused collimated beam
d. The interference of the spatially filtered plane wave beam following the spatial filter with a reference plane wave with interference occurring in the plane of a detector.
e. The subsequent extraction of the phase information within the reflected collimated plane waves collected from the specimen to obtain meteorologically accurate three-dimensional measurements of features in the specimen plane.
f. The use of said meteorologically accurate three-dimensional measurements to computationally form a three dimensional image of specimen features.

7. The improvement of claim 6 wherein the reference plane wave passes through the same spatial filter as the plane wave reflected from the specimen surface.

8. The improvement of claim 6 wherein the reference plane wave does not passe through the same spatial filter as the plane wave reflected from the specimen surface.

9. An improvement to the optical interferometric system of U.S. Pat. No. 7,136,168 B2, “Interferometric Topological Metrology with Pre-Established Reference Scale” comprising the use of focusing optics to create a small field of view illuminated by plane waves comprising:
a. A focusing lens to focus a collimated beam of plane wave light from a laser to form a spot of predetermined diameter in the plane of the specimen
b. The use of the a different lens to re-collimate light transmitted through the specimen
c. The interference of the transmitted re-collimated plane waves collected from the specimen with a reference plane wave with interference occurring in the plane of a detector
d. The subsequent extraction of the phase information within the reflected collimated plane waves collected from the specimen surface to obtain meteorologically accurate three-dimensional measurements of features in the specimen plane.
e. The use of the meteorologically accurate three-dimensional measurements to computationally form a three dimensional image of specimen features.

10. An improvement to the optical interferometric system of U.S. Pat. No. 7,136,168 B2, “Interferometric Topological Metrology with Pre-Established Reference Scale” comprising the use of focusing optics to create a small field of view illuminated by plane waves comprising:
a. A focusing lens to focus a collimated beam of plane wave light from a laser to form a spot of predetermined diameter in a focal plane located within the body of a nominally optically transparent material
b. The use of a focusing lens to re-collimate the light from specimen features located substantially in said focal plane within the nominally optically transparent material
c. The interference of the re-collimated plane waves collected from the specimen with a reference plane wave with interference occurring in the plane of a detector
d. The subsequent extraction of the phase information within the reflected collimated plane waves collected from the specimen to obtain meteorologically accurate three-dimensional measurements of features in the specimen plane.
e. The use of the meteorologically accurate three-dimensional measurements to computationally form a three dimensional image of features within the nominally transparent specimen material

11. The improvement of claim 10 wherein the focusing lens and the re-collimating lens are the same element

12. The improvement of claim 10 wherein light is reflected from features within the specimen material

13. The improvement of claim 10 wherein light is transmitted through features within the specimen material

14. An improvement to the optical interferometric system of U.S. Pat. No. 7,136,168 B2, “Interferometric Topological Metrology with Pre-Established Reference Scale” comprising the use of focusing optics to create a small field of view illuminated by plane waves comprising:
a. A focusing lens to focus a collimated beam of plane wave light from a laser to form a spot of predetermined diameter in a focal plane located within the body of a nominally optically transparent material
b. The use of a reflective surface located below said focal plane to redirect light back towards the source so that it passes through features in the nominally transparent specimen material twice.
c. The use of a focusing lens to re-collimate the light from specimen features located substantially in said focal plane within the nominally optically transparent material
d. The interference of the re-collimated plane waves collected from the specimen with a reference plane wave with interference occurring in the plane of a detector
e. The subsequent extraction of the phase information within the reflected collimated plane waves collected from the specimen to obtain meteorologically accurate three-dimensional measurements of features in the specimen plane.
g. The use of the meteorologically accurate three-dimensional measurements to computationally form a three dimensional image of features within the nominally transparent specimen material

15. The improvement of claim 14 wherein the focusing lens and the re-collimating lens are the same element
